(19) United States
(12) Patent Application Publication
(10) Pub. No.: US 2025/0390791 A1
(43) Pub. Date: Dec. 25, 2025

(54) COMPUTER-BASED SYSTEMS CONFIGURED FOR EVALUATING AND SELECTING MACHINE-LEARNING MODELS AND METHODS OF USE THEREOF

(71) Applicant: Capital One Services, LLC, McLean, VA (US)

(72) Inventor: Michael Langford, Plano, TX (US)

(21) Appl. No.: 18/753,566

(22) Filed: Jun. 25, 2024

(51) Int. Cl. G06N 20/00

(52) U.S. Cl. CPC G06N 20/00

(57) ABSTRACT

The present disclosure describes a method including receiving a plurality of datasets, executing a plurality of machine-learning models on each of the plurality of datasets, generating, for each of the plurality of datasets, a label identifying a best performing one of the plurality of machine-learning models, the best performing one of the plurality of machine-learning models being evaluated based on performance evaluations derived from executing the plurality of the machine-learning models on a same one of the plurality of datasets, extracting a set of profiles from each of the plurality of datasets, associating the label with the set of profiles of the same dataset for each of the plurality of datasets, generating a meta dataset from a plurality of label-associated sets of profiles, and running a estimating machine-learning model on the meta dataset to select one of the plurality of the machine-learning models as a trained machine-learning model.

### FIELD OF TECHNOLOGY

The present disclosure generally relates to machine learning, and more particularly to computer-based systems configured for evaluating and selecting machine-learning models and methods of use thereof.

### BACKGROUND OF TECHNOLOGY

Machine learning is a form of artificial intelligence (AI) that enables a system to learn from data rather than through explicit programming. A major focus of machine-learning research is to automatically learn to recognize complex patterns and make intelligent decisions based on data, and more efficiently train machine-learning models and pipelines. A machine-learning model is the output generated when a machine-learning algorithm is trained with data. After the training, input is provided to the machine-learning model which then generates an output. For example, a predictive algorithm may create a predictive model. Then, the predictive model is provided with data and a prediction is then generated (e.g., “output”) based on the data that trained the model.

The generation of a machine-learning model typically entails defining a question, creating a solution, interpreting and evaluating the results, comparing those results to other solutions, and, often, iterating on the question definition to begin the cycle again. Subsequently, it is important to evaluate the performance or accuracy of the model in response to new, previously unseen (i.e., “out-of-sample”) data, to ensure long-term reliability. As such, it is desirable to have a system and method to evaluate and select a machine-learning model for a given dataset.

### SUMMARY OF DESCRIBED SUBJECT MATTER

In at least some embodiments, or in combination with at least one other embodiment described herein, the present disclosure provides a technically improved method, executed by at least one computing device, including receiving a plurality of datasets; executing a plurality of machine-learning models on each of the plurality of datasets; generating, by the at least one computing device, for each of the plurality of datasets, a label identifying a best performing one of the plurality of machine-learning models, the best performing one of the plurality of machine-learning models being evaluated based on performance evaluations derived from executing the plurality of the machine-learning models on a same one of the plurality of datasets; executing a predetermined dataset profiler to extract a set of profiles from each of the plurality of datasets; associating the label with the set of profiles of the same one of the plurality of datasets for each of the plurality of datasets to form a plurality of label-associated sets of profiles; generating a meta dataset from the plurality of label-associated sets of profiles; and running a predetermined estimating machine-learning model on the meta dataset to select one of the plurality of the machine-learning models as a trained machine-learning model.

In at least some embodiments, or in combination with at least one other embodiment described herein, the method further including generating a machine-learning pipeline comprising the executing the plurality of machine-learning models on the plurality of datasets to generate the labels, extracting dataset profiles, generating a meta dataset from the labels and profiles, and running the estimating machine-learning model on the meta dataset.

In at least some embodiments, or in combination with at least one other embodiment described here, the plurality of datasets includes user provided real tabular datasets, where each of the real tabular datasets includes a target column as a first column thereof.

In at least some embodiments, or in combination with at least one other embodiment described herein, the plurality of datasets includes a plurality of tabular datasets synthesized with one or more user inputted parameters, where the one or more user inputted parameters include bounds on a number of rows in the tabular dataset and a number of features in the tabular dataset.

In at least some embodiments, or in combination with at least one other embodiment described herein, the performance evaluations include quantitative metrics such as F1 score, root mean squared error (RMSE), accuracy, area under the receiver operating characteristic curve (AUC-ROC), mean absolute error (MAE), and any combination of thereof.

In at least some embodiments, or in combination with at least one other embodiment described herein, the dataset profiler may be configured to extract profiles such as a number of observations in the dataset, a feature count, a class ratio, a percentage of duplicate records, a percent of features that have binary data, and any combination thereof.

In at least some embodiments, or in combination with at least one other embodiment described herein, the predetermined estimating machine-learning model may be a gradient boosted tree model.

In at least some embodiments, or in combination with at least one other embodiment described herein, the selected one of the plurality of the machine-learning models may be a best performing one of the plurality of the machine-learning models on the meta dataset.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is a block diagram illustrating an exemplary process for evaluating machine-learning models in accordance with one or more embodiments of the present disclosure.

FIG. 2 is a block diagram illustrating an exemplary process for extracting profiles from datasets in accordance with one or more embodiments of the present disclosure.

FIG. 3 is a block diagram illustrating an exemplary process for constructing a meta dataset from dataset profiles in accordance with one or more embodiments of the present disclosure.

FIG. 4 is a block diagram illustrating an exemplary process for identifying a trained machine-learning model from the meta dataset in accordance with one or more embodiments of the present disclosure.

FIG. 5 is a flowchart illustrating an exemplary process for identifying a trained machine-learning model in accordance with one or more embodiments of the present disclosure.

FIG. 6 is a block diagram of a computing system for implementing the processes depicted in FIGS. 1 – 5 in accordance with one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term "based on" is not exclusive and allows for being based on additional factors not described, unless the context clearly dictates otherwise. In addition, throughout the specification, the meaning of "a," "an," and "the" include plural references. The meaning of "in" includes "in" and "on."

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

In at least some embodiments, the present disclosure is directed to exemplary method for invisibly authenticating a bank account access request.

In at least some embodiments, the present disclosure may be directed to addressing a technological problem with efficiently evaluating and selecting machine models for given datasets.

At least some embodiments of the present disclosure herein describe an illustrative a method including receiving a plurality of datasets, executing a plurality of machine-learning models on each of the plurality of datasets, generating, for each of the plurality of datasets, a label identifying a best performing one of the plurality of machine-learning models, the best performing one of the plurality of machine-learning models being evaluated based on performance evaluations derived from executing the plurality of the machine-learning models on a same one of the plurality of datasets, extracting a set of profiles from each of the plurality of datasets, associating the label with the set of profiles of the same dataset for each of the plurality of datasets, generating a meta dataset from a plurality of label-associated sets of profiles, and running a estimating machine-learning model on the meta dataset to select one of the plurality of the machine-learning models as a trained machine-learning model.

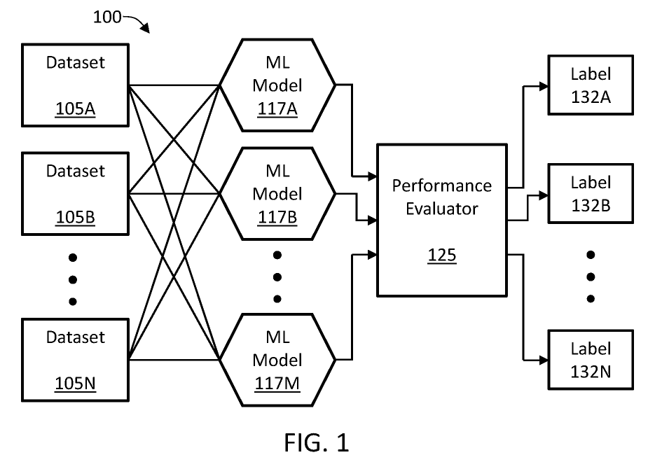

FIG. 1 is a block diagram illustrating an exemplary process 100 for evaluating machine-learning models in accordance with at least some embodiments of the present disclosure. For evaluating M number of machine-learning (ML) models 117A – 117M, where M is an integer larger than 1, N number of datasets 105A – 105N are provided to be run by the ML models 117A – 117M. As shown in FIG. 1, dataset 105A runs on every ML model 117A – 117M, and each result may be provided to performance evaluator 125, which identifies a best performing ML model for dataset 105A, and represents the best performing ML model with a label 132A.

In at least some embodiments, or in combination with at least one other embodiment described herein, a ML model’s performance may be evaluated based on both quantitative metrics and/or qualitative assessment. Quantitative metrics include F1 score, root mean squared error (RMSE), accuracy, area under the receiver operating characteristic curve (AUC-ROC), and mean absolute error (MAE). F1 score is a harmonic mean of precision and recall, useful for imbalanced datasets. RMSE is commonly used for regression tasks to measure prediction accuracy. Accuracy is the proportion of correctly classified instances. AUS-ROC evaluates binary classification models. MAE is another metric for regression tasks.

Qualitative assessment may be performed by subject matter experts accessing results qualitatively. The experts consider factors like interpretability, domain-specific relevance, and practical implications.

In addition, a user may also input a chosen metric to optimize for fitting the datasets, and supplies one for each classification and regression if both tasks are present in the datasets.

Similarly, dataset 105B runs on every ML model 117A – 117M, and each result may be provided to performance evaluator 125, which identifies a best performing ML model for dataset 105B, and represents the best performing ML model with a label 132B.

The about process may be performed on every dataset. For example, a best performing ML model for dataset 105N may be represented by a label 132N.

In at least some embodiments, or in combination with at least one other embodiment described herein, a 10-fold cross-validation strategy may be employed evaluating the ML models 117A – 117M. Cross-validation (CV) may be a statistical method used to estimate the skill of machine-learning models. In 10-fold cross-validation, the dataset may be divided into 10 equally sized subsets (or “folds”). The model may be trained and evaluated 10 times, using a different fold as the validation set each time. Performance metrics from each fold are averaged to estimate the model’s generalization performance.

The 10-fold cross-validation provides a more robust estimate of model performance than a single train-test split. By rotating through different subsets, it helps assess how well the model generalizes to unseen data. It reduces the risk of overfitting or underfitting by using multiple validation sets.

In an embodiment, a procedure to perform the 10-fold cross-validation includes dividing the dataset into 10 subsets (folds); training the model on 9 folds and validate it on the remaining fold; repeat this process 10 times, using a different fold for validation each time; and average the performance metrics across all folds.

Although the 10-fold cross-validation may be exemplarily employed, other number of folds (e.g., 5 or 15) may also be used. Smaller number of folds may lead to higher variance, while larger number of folds may increase computational cost. Thus, the chosen number of folds should depend on trade-offs based on specific dataset and computational resources.

In at least some embodiments, or in combination with at least one other embodiment described herein, the datasets 105A – 105N may be real tabular datasets inputted by a user or synthetic tabular datasets. The real tabular datasets can either be classification, regression, or a mix of both, so long as the target column is the first column in each of the datasets. If synthetic tabular datasets are chosen, the user can optionally input parameters for how sampling of synthetic datasets may be done (such as bounds on the number of rows in the datasets, number of features in the datasets, and so on), but defaults may be provided.

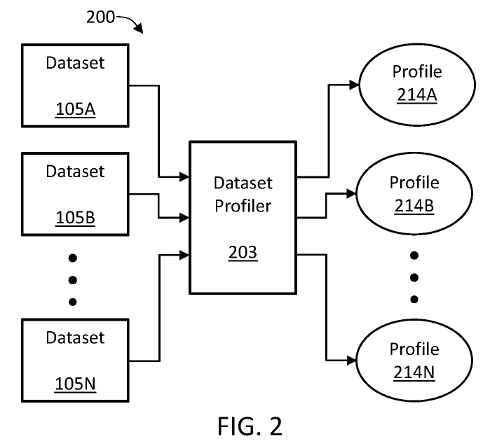

FIG. 2 is a block diagram illustrating an exemplary process 200 for extracting profiles from datasets in accordance with one or more embodiments of the present disclosure. Datasets 105A – 105N, in addition to running the models 117A – 117M, are also provided to a dataset profiler 203 to generate profile 214A from dataset 105A, profile 214B from dataset 105B, … and profile 214N from dataset 105B. Data profiling is a systematic process that involves determining and recording characteristics of datasets. Data profiling may help to understand how the data is structured, and gain insights into data quality by reviewing and summarizing it. In an embodiment, datasets are loaded into a data profiling library which is a tool or software package that assists in understanding and analyzing data. In an implementation, a data profiling library automatically formats and loads files into a data frame. Then the data profiling library identifies the schema, statistics, and entities (such as personally identifiable information or non-public information) within the data. The data profiling library may also come with a pre-trained deep learning model for efficient sensitive data detection.

As shown in FIG. 2, the dataset profiler 203 may be run on one dataset at a time, and extract several details about the dataset to form a set of profiles. These details may include, but are not limited to, a number of observations in the dataset, a feature count, a class ratio (if classification), a percentage of duplicate records, or a percent of features that have binary data. Optionally the user may also provide extra information to the dataset profiler 203 for guiding the extraction of each of the datasets 105A – 105N. However, default details may be provided to the dataset profiler 203.

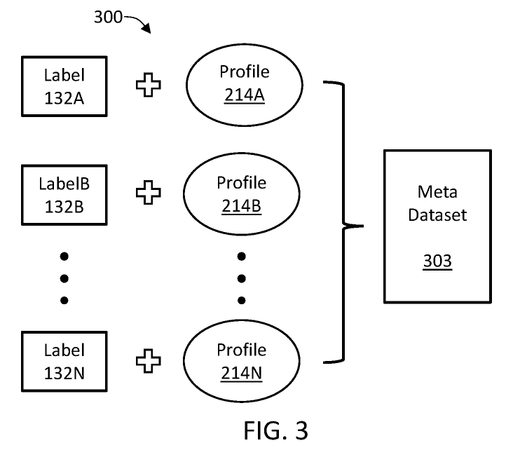

FIG. 3 is a block diagram illustrating an exemplary process 300 for constructing a meta dataset from dataset profiles in accordance with one or more embodiments of the present disclosure. The exemplary process 300 associates a label with a profile of a same dataset and then collect all the label-associated profiles into the meta dataset 303. For example, label 132A which is derived from dataset 105A is associated with data profile 214A which is extracted also from dataset 105A; label 132B which is derived from dataset 105B is associated with data profile 214B which is extracted also from dataset 105B; … and label 132N which is derived from dataset 105N is associated with data profile 214N which is extract also from dataset 105N.

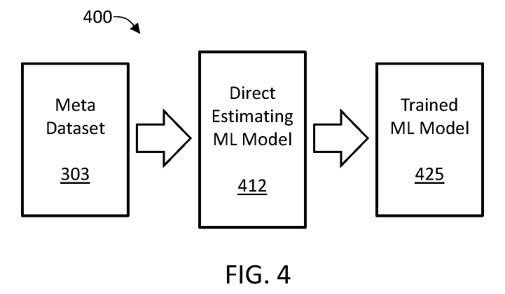

FIG. 4 is a block diagram illustrating an exemplary process 400 for identifying a trained machine-learning model from the meta dataset in accordance with one or more embodiments of the present disclosure. The exemplary process 400 runs the meta dataset 303 constructed from label-associated dataset profiles through a direct estimating machine-line model 412 to identify one of the ML models 117A – 117M to be a trained ML model 425 to be outputted to the user. In an embodiment, a gradient-boosted tree model run in multiclass model may be used to fit the meta dataset 303 to a target best model as the trained ML machine 425.

The exemplary gradient boosted tree model may be an ensemble of either regression or classification tree models. It is a forward-learning ensemble method that obtains predictive results through gradually improved estimations. Boosting is a flexible nonlinear regression procedure that helps improve the accuracy of trees. Gradient boosting is a methodology applied on top of another machine-learning algorithm. It involves two types of models: a "weak" machine-learning model, which is typically a decision tree, and a "strong" machine-learning model, which is composed of multiple weak models.

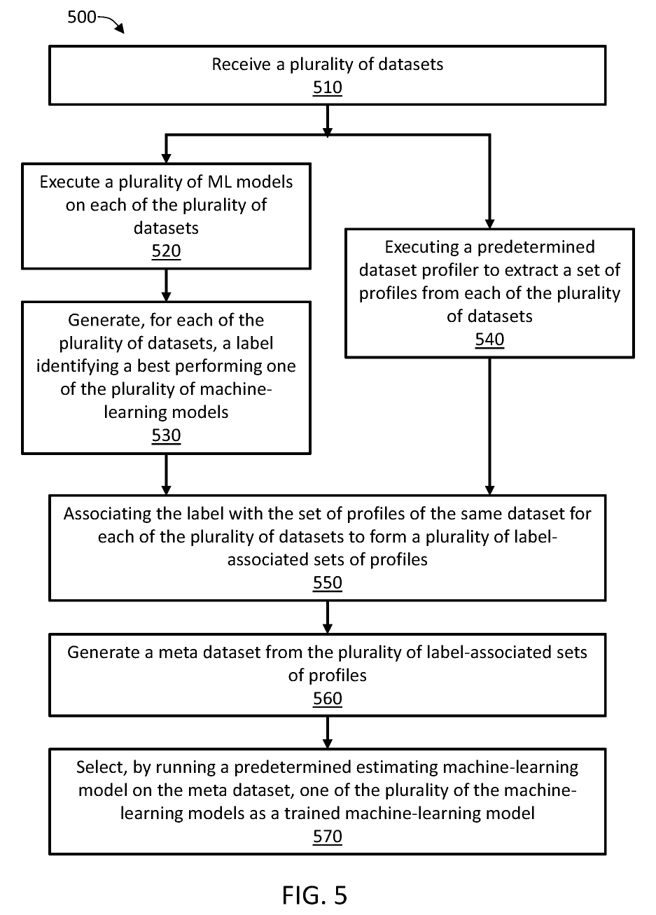

FIG. 5 is a flowchart illustrating an exemplary process 500 for identifying a trained machine-learning model in accordance with one or more embodiments of the present disclosure. The process 500 may be executed in at least one computing device and begins with receiving a plurality of datasets 105A – 105N in block 510. In block 520, the process 500 executes a plurality of ML models 117A – 117M on each of the plurality of datasets 105A – 105N. In block 530, the process 500 generates, for each of the plurality of datasets 105A – 105N, a label (132A – 132N) identifying a best performing one of the plurality of machine-learning models. In an embodiment, the best performing one of the plurality of machine-learning models 117A – 117M may be evaluated based on performance evaluations derived from executing the plurality of the machine-learning models on a same one of the plurality of datasets. The performance evaluations may be quantitative metrics and/or qualitative assessment.

Referring again to FIG. 5, the process 500 in block 540 executes a predetermined dataset profiler 203 to extract a set of profiles 214A – 214N from each of the plurality of datasets. Then both the labels 132A – 132N generated in block 530 and the sets of profiles 214A – 214N extracted in block 540 are provided to block 550, where the process 500 associates the label with the set of profiles of the same dataset for each of the plurality of datasets 105A – 105N to form a plurality of label-associated sets of profiles. In block 560, the process 500 generates a meta dataset 303 from the plurality of label-associated sets of profiles. In block 570, the process 500 selects, by running a predetermined estimating ML model on the meta dataset, one of the plurality of the machine-learning models as a trained machine-learning model. In an embodiment, the estimating ML model may be a gradient boosted tree model. The selected ML model may be a best performing one of the plurality of ML models on the meta dataset.

In at least some embodiments, or in combination with at least one other embodiment described herein, the process 500 also generates a machine-learning pipeline with procedures depicted in blocks 510 – 570 in FIG. 5. The pipeline includes the executing a given plurality of machine-learning models to generate labels for the best performing ones, extracting dataset profiles, generating a meta dataset from the labels and profiles, and running the estimating ML model on the meta dataset to select a best one of the plurality of ML model.

The machine-learning pipeline may be designed to automate, standardize, and streamline the process of building, training, evaluating, and deploying machine-learning models. Benefits of the machine-learning pipelines includes modularization, reproducibility, efficiency, scalability, experimentation, deployment and collaboration.

Modularization refers to pipelines breaking down the machine-learning process into modular, well-defined steps. Each step can be developed, tested, and optimized independently, making it easier to manage and maintain the workflow.

Reproducibility refers to a fact that by defining the sequence of steps and their parameters in a pipeline, experiments can be recreated exactly, ensuring consistent results. If a step fails or model performance deteriorates, the pipeline can raise alerts or take corrective actions.

Efficiency refers to pipelines automating routine tasks like data preprocessing, feature engineering, and model evaluation, saving time and reducing errors.

Scalability refers to pipelines being easily scaled to handle large datasets or complex workflows without reconfiguring everything from scratch.

Experimentation refers to modifying individual steps within the pipeline to experiment with different techniques, selections, and models for rapid iteration and optimization.

Deployment refers to facilitating model deployment into production by integrating the well-defined pipeline.

Collaboration refers to structured workflows making it easier for data science teams to collaborate and contribute.

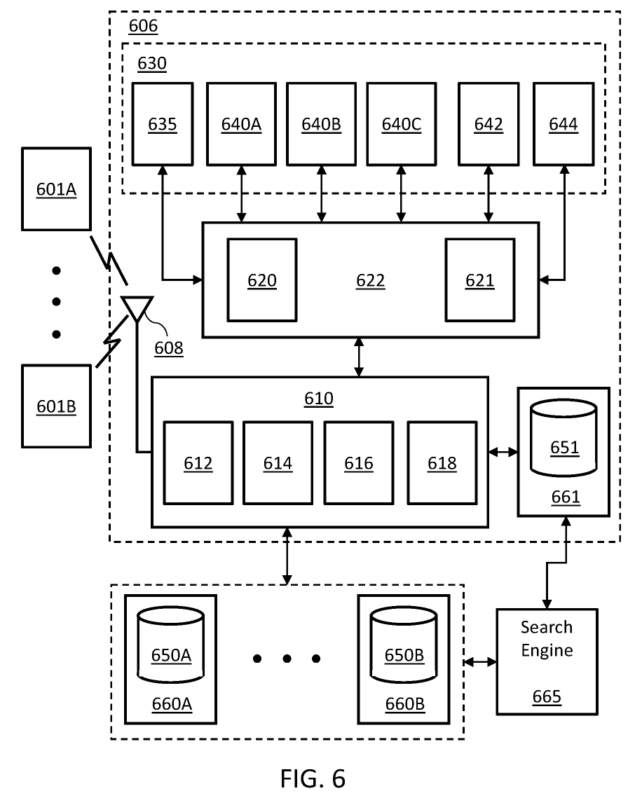

FIG. 6 is a block diagram of a computing system 600 for implementing the processes depicted in FIGS. 1 – 5 in accordance with one or more embodiments of the present disclosure. Aspects of the present disclosure may be applied to an exemplary real-time entity-resolution (RTER) microservices platform 606 that may include RTER software modules denoted 635, 640A, 640B, and 640C for implementing the RTER microservices in a service layer 630 as described hereinbelow. At least one search query generator software module 642 may be configured to generate of search queries in response to an entity-specific data request for entity-specific data from a user via a graphical user interface (GUI).

In at least some embodiments, or in combination with at least one other embodiment described herein, the RTER microservices platform 606 may include a multi-layered architecture including, for example, the service layer 630, an orchestration layer 622, and a platform layer 610, however other layers may be additionally contemplated. In some embodiments, a plurality of users may interact with the RTER microservices platform 606 via any of N user devices denoted 601A … 601B, where N may be an integer. The N user devices denoted 601A … 601B may include the GUI for any number of users to interact with the RTER microservices platform 606. FIG. 6 shows the first user device 601A and the Nth user device 601B. Communications from the user devices 601A … 601B may be received by a transceiver 608 and may then be routed to an appropriate component of the system, via the platform layer 610, for example.

In at least some embodiments, or in combination of at least one other embodiment described herein, the platform layer 610 may include an input/output (I/O) interface 612 for facilitating data communication to external devices, such as, e.g., the transceiver 608 with any other system devices. The platform layer 610 may also include a runtime environment 614 for implementing programs, services, functionalities and microservices using a plurality of processors 616 and memory devices 618 for implementing the RTER microservices platform 606. The memory devices 618 may include, e.g., temporary storage and caching of data to facilitate resources of the RTER microservices platform 606. In some embodiments, the platform layer 610 includes functionality for, e.g., configuration management, logging and monitoring of data traffic, document management, communication routing, notifications, messaging tools, reporting tools, as well as any other functions pertaining to platform level functionality.

In at least some embodiments, or in combination of at least one other embodiment described herein, a request from any of the user devices 601A and 601B may be routed to an orchestrator 620 in the orchestration layer 622. In other embodiments, the orchestrator 620 may manage operations of the RTER microservices platform 606, including allocation of resources, process schedule with, e.g., the plurality of processors 616, among other tasks. For example, in some embodiments, the orchestrator 620 may include a plurality of application programming interfaces (APIs) 621 for calling services and functions of the RTER microservices platform 606 in interacting with the user devices 601A … 601B.

In at least some embodiments, or in combination of at least one other embodiment described herein, the orchestrator 620 may manage operations of microservices in a service layer 630 and coordination of the service layer 630 with the platform layer 610. For example, the service layer 630 may include software modules 635, 640A, 640B, and 640C related to, for example, implementing the RTER microservices platform 606 and the at least one search query generator software module 642 to generate search queries for the search engine 665. In some embodiments, the orchestrator 620 may facilitate aggregation of data from multiple domains in the service layer 630 and/or may orchestrate data-related operations across domains and services to provide for complete experiences within any given domain.

In at least some embodiments, or in combination of at least one other embodiment described herein, the service layer 630 may also include at least one shared microservice 644 that may include functionality that may be shared across multiple domains.

In at least some embodiments, or in combination of at least one other embodiment described herein, the orchestrator 620 may manage the data flow and the execution of microservices such that data may be shared, processed, and returned to any of the N user devices 601A … 601B. For example, a user device such as the user device 601A may communicate a request, e.g., a user interaction via a GUI of the user device 601A. The request may be received by the transceiver 608 and routed via the platform layer 610 to the orchestrator 620. A search request may be entered by the user into the GUI on a particular user device from any of the N user devices 601A … 601B and the search results may be displayed in the GUI of the particular user device for the user to analyze.

In at least some embodiments, or in combination of at least one other embodiment described herein, the computing system 600 may include a plurality of M electronic resources denoted 660A… 660B on which a plurality of M databases may be stored and respectively denoted as 650A … 650B where M may be an integer. An additional electronic resource 661 may include an entity profile database 651. The plurality of M electronic resources 660A … 660B and the additional electronic resource 661 may be communicatively coupled to the RTER microservices platform 606.

In at least some embodiments, or in combination of at least one other embodiment described herein, the plurality of M databases 650A … 650B may include the entity profile database 651. In other embodiments, the entity profile database 651 may be separate from the plurality of M databases 650A … 650B. In yet other embodiments, In other embodiments, the entity profile database 651 may be separate from, but communicatively coupled to the plurality of M databases 650A … 650B.

In at least some embodiments, or in combination of at least one other embodiment described herein, the RTER microservices platform 606 may be communicatively coupled to send and receive data to a search engine 665.

In at least some embodiments, or in combination of at least one other embodiment described herein, the plurality of M electronic resources 660A … 660B and the additional electronic resource 661 may be communicatively coupled with the search engine 665.

In at least some embodiments, or in combination of at least one other embodiment described herein, the search engine 665 may be an Elasticsearch search engine. The Elasticsearch search engine may be based on a Lucene library. It may be a distributed, multitenant-capable full-text search engine with a HTTP web interface and schema-free JSON documents.

In at least some embodiments, or in combination of at least one other embodiment described herein, any data stored on any of the plurality of databases 650A … 650B, such as entity-specific data associated with any of a plurality of entities may be accessible from the N user devices 601A … 601B via any of the plurality of APIs in the orchestrator 620 in the RTER microservices platform 606. User access may require proper user access authentication.

In at least some embodiments, or in combination of at least one other embodiment described herein, each of plurality of M electronic resources (ER) denoted 660A … 660B may include at least one ER processor and/or ER controller, ER input and/or ER output devices, and/or ER communication circuitry for communicating over a communication network with any of the elements and/or devices in the computing system 600. API calls via any of the plurality of APIs 621 to the at least ER processor and/or ER controller may be programmed to search for and/or process entity-specific data stored in any of the plurality of M databases.

In at least some embodiments, or in combination of at least one other embodiment described herein, for efficient processing of initial business data for generating the ElasticSearch search query, API calls to an entity profile database 651 stored in an electronic resource 661 may include data-reducing hashing functions to reduce the size of the initial business data for a particular business that may be returned to the microservice as compress data. The entity-specific data in the entity profile database 651 may then be decompressed by the original hash function and/or by algorithms based on the hash function used in the original API calls. Moreover, the hash function algorithms may cluster business data features from the compress data. These clustered features may be used by the algorithms to generate an ElasticSearch query that streamlines the search coverage.

In at least some embodiments, or in combination of at least one other embodiment described herein, the entity profile database 651 from the plurality of M databases 650A … 650B may be stored on the electronic resource 661 from the plurality of electronic resources coupled to the microservice RTER platform 606 and/or may require authentication to access.

In at least some embodiments, or in combination of at least one other embodiment described herein, the entity profile database 651 may be separate from the plurality of M databases 650A…150B and may be directly assessable from the microservice RTER platform 606 as shown in FIG. 6.

In at least some embodiments, or in combination of at least one other embodiment described herein, the first exemplary flow for managing the search engine results may further include the orchestrator 620 may join the blocking module 640A output and the scoring module 640C output and may transmit all of the matching pairs, their matching scores, entity (business) firmographics, and/or transaction data to the user on one of the N user devices 601A…101B.

In at least some embodiments, or in combination of at least one other embodiment described herein, a second exemplary flow for managing the search engine results may further include all of the functionality of the featurizer module 640B, and/or the scoring module 640C as described herein above. However, to more efficiently manage the search engine results before receiving the search results, the at least one search query generator software module 642 may include an algorithm to take the data in the entity-specific data request to generate the entity-specific database query request that may be crafted to reduce extraneous search results hits.

In at least some embodiments, or in combination of at least one other embodiment described herein, the entity resolution microservice platform 606 may update at least one entity profile in the entity profile database 651 for the at least one entity with the additional entity-specific data.

In at least some embodiments, or in combination of at least one other embodiment described herein, the at least one entity may be a business. The at least one entity profile may be a profile of the business. The entity-specific data may include business data from the search engine associated with the business. Thus, the entity resolution microservice platform 606 may update the profile of the business with the business data received from the search engine 665.

In at least some embodiments, or in combination of at least one other embodiment described herein, the entity resolution microservice platform 606 may receive the search engine results data comprising entity-specific data records. Each entity-specific data record may include a matching score. In other embodiments, the scoring module 640C may generate the matching score. The matching score may be indicative of a match between the entity-specific data in each entity-specific data record and the entity-specific data in the entity-specific database query request associated with the at least one entity.

For example, in the previous example described hereinabove illustrates the scoring module 640C assigning a matching score to each of the search results for the entity name in the entity-specific data based the entity name (Gil Ellis) in the entity-specific data request. However, the types of entity specific data are not limited to the entity name, but may also include the entity owner, the entity address etc. The search results may include search hits for each type of entity-specific data in the entity-specific data request that are each scored within each respective type of entity specific data. The search engine may receive search results hits for the different types of entity-specific data, each receiving a matching score. The search results hits for the different types of entity-specific data may be unordered.

In at least some embodiments, or in combination of at least one other embodiment described herein, the entity resolution microservice platform 606 may perform an ordering of the entity-specific data for each type from a highest matching score to a lowest matching score and to store a secondary file of the search engine results data with entity-specific data records having a predefined number of highest matching scores. The secondary file may include the entity-specific data with the highest matching score for each given type so as to capture, for example, the search hit with the highest matching score for each type (e.g., the entity name, entity address, entity owner name, and the like).

In at least some embodiments, or in combination of at least one other embodiment described herein, the predefined number of highest matching scores may include 40 search engine results with the highest matching scores. The predefined number of highest matching scores may include 400 search engine results with the highest matching scores. The predefined number of highest matching scores may include 500 search engine results with the highest matching scores. The predefined number of highest matching scores may include 4000 search engine results with the highest matching scores. The predefined number of highest matching scores may include 5000 search engine results with the highest matching scores. The predefined number of highest matching scores may include 40,000 search engine results with the highest matching scores.

In at least some embodiments, or in combination of at least one other embodiment described herein, the entity resolution microservice platform 606 may generate an index for each entity-specific data record in the secondary file since the search results hits for the different types of entity-specific data may be unordered.

In at least some embodiments, or in combination of at least one other embodiment described herein, the entity resolution microservice platform 606 may apply the same index during another search to the search engine results data for the entity-specific data associated with the at least one entity in response to another entity-specific data request that generates another entity-specific database query request for the search engine identical to the entity-specific database query request. (Note that the indexing may be applied to either of the first and second exemplary flows or both for managing the search results.)

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment may be implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as "IP cores" may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In at least some embodiments, or in combination of at least one other embodiment described herein, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In at least some embodiments, or in combination of at least one other embodiment described herein, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to: (1) FreeBSD, NetBSD, OpenBSD; (2) Linux; (3) Microsoft Windows; (4) OS X (MacOS); (5) MacOS 41; (6) Solaris; (7) Android; (8) iOS; (9) Embedded Linux; (10) Tizen; (11) WebOS; (12) IBM i; (13) IBM AIX; (14) Binary Runtime Environment for Wireless (BREW); (15) Cocoa (API); (16) Cocoa Touch; (17) Java Platforms; (18) JavaFX; (19) JavaFX Mobile; (20) Microsoft DirectX; (21) .NET Framework; (22) Silverlight; (23) Open Web Platform; (24) Oracle Database; (25) Qt; (26) Eclipse Rich Client Platform; (27) SAP NetWeaver; (28) Smartface; and/or (29) Windows Runtime.

In at least some embodiments, or in combination of at least one other embodiment described herein, exemplary inventive computer-based systems/platforms, exemplary inventive computer-based devices, and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a "tool" in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

As used herein, the terms "cloud," "Internet cloud," "cloud computing," "cloud architecture," and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In at least some embodiments, or in combination of at least one other embodiment described herein, the exemplary inventive computer-based systems/platforms, the exemplary inventive computer-based devices, and/or the exemplary inventive computer-based components of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTR0, SHA-1, SHA-2, Tiger (TTH),WHIRLPOOL, RNGs).

The aforementioned examples are, of course, illustrative and not restrictive.

As used herein, the term "user" shall have a meaning of at least one user. In some embodiments, the terms "user", "subscriber" "consumer" or "customer" should be understood to refer to a user of an application or applications for implementing the functions of the CVCP as described herein and/or a consumer of data supplied by a data provider. By way of example, and not limitation, the terms "user" or "subscriber" can refer to a person who receives data provided by the data or service provider over the Internet in a browser session, or can refer to an automated software application which receives the data and stores or processes the data.

In at least some embodiments, or in combination of at least one other embodiment described herein, exemplary inventive computer-based systems/platforms, exemplary inventive computer-based devices, and/or exemplary inventive computer-based components of the present disclosure may be configured to handle numerous concurrent users via the N user devices 601A and 601B that may be, but is not limited to, at least 400 (e.g., but not limited to, 400-999), at least 4,000 (e.g., but not limited to, 4,000-9,999 ), at least 40,000 (e.g., but not limited to, 40,000-99,999 ), at least 400000 (e.g., but not limited to, 400,000-999,999), at least 4,000,000 (e.g., but not limited to, 4,000,000-9,999,999), at least 40,000,000 (e.g., but not limited to, 40,000,000-99,999,999), at least 400000000 (e.g., but not limited to, 400,000,000-999,999,999), at least 4,000,000,000 (e.g., but not limited to, 4,000,000,000-999,999,999,999), and so on.

In at least some embodiments, or in combination of at least one other embodiment described herein, the illustrative computing devices and the illustrative computing components of the exemplary computer-based system 600 and platform 606 may be configured to manage a large number of members and concurrent transactions, as detailed herein. In some embodiments, the exemplary computer-based system 600 and platform 606 may be based on a scalable computer and network architecture that incorporates varies strategies for assessing the data, caching, searching, and/or database connection pooling.

In at least some embodiments, or in combination of at least one other embodiment described herein, the N client (user) devices 601A through 601B may be personal computers, multiprocessor systems, microprocessor-based or programmable consumer electronics, network PCs, and the like. In some embodiments, one or more client devices within the N client devices 601A through 601B may include computing devices that typically connect using a wireless communications medium such as cell phones, smart phones, pagers, walkie talkies, radio frequency (RF) devices, infrared (IR) devices, citizens band radio, integrated devices combining one or more of the preceding devices, or virtually any mobile computing device, and the like. In some embodiments, one or more client devices within client devices !02 through !04 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that may be equipped to communicate over a wired and/or wireless communication medium (e.g., NFC, RFID, NBIOT, 3G, 4G, 5G, GSM, GPRS, WiFi, WiMax, CDMA, OFDM, OFDMA, LTE, satellite, ZigBee, etc.).

In at least some embodiments, or in combination of at least one other embodiment described herein, one or more client devices within the N client devices 601A through 601B may include may run one or more applications, such as Internet browsers, mobile applications, voice calls, video games, videoconferencing, and email, among others. In some embodiments, one or more client devices within the N client devices 601A through 601B may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a client device within client devices 602 through 604 may be specifically programmed by either Java, .Net, QT, C, C++, Python, PHP and/or other suitable programming language. In some embodiment of the device software, device control may be distributed between multiple standalone applications. In some embodiments, software components/applications can be updated and redeployed remotely as individual units or as a full software suite. In some embodiments, a client device may periodically report status or send alerts over text or email. In some embodiments, a client device may contain a data recorder which may be remotely downloadable by the user using network protocols such as FTP, SSH, or other file transfer mechanisms. In some embodiments, a client device may provide several levels of user interface, for example, advance user, standard user. In some embodiments, one or more client devices within the N client devices 601A through 601B may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments and, optionally, in combination of any embodiment described above or below, for example, the N client devices 601A through 601B, and/or the exemplary platform 606 may include a specifically programmed software module in the service layer 630 that may be configured to send, process, and receive information using a scripting language, a remote procedure call, an email, a tweet, Short Message Service (SMS), Multimedia Message Service (MMS), instant messaging (IM), an application programming interface, Simple Object Access Protocol (SOAP) methods, Common Object Request Broker Architecture (CORBA), HTTP (Hypertext Transfer Protocol), REST (Representational State Transfer), SOAP (Simple Object Transfer Protocol), MLLP (Minimum Lower Layer Protocol), or any combination thereof.

In at least some embodiments, or in combination of at least one other embodiment described herein, the N client devices 601A through 601B as well as the I/O devices in the platform layer 610 may also include a number of external or internal devices such as a mouse, a CD-ROM, DVD, a physical or virtual keyboard, a display, or other input or output devices. In some embodiments, examples of the N client devices 601A through 601B as well as devices in the platform layer 610 may be any type of processor-based platforms that are connected to a network such as, without limitation, personal computers, digital assistants, personal digital assistants, smart phones, pagers, digital tablets, laptop computers, Internet appliances, and other processor-based devices. In some embodiments, client devices 601A through 601B may be specifically programmed with one or more application programs in accordance with one or more principles/methodologies detailed herein. In some embodiments, the N client devices 601A through 601B as well as devices in the platform layer 610 may operate on any operating system capable of supporting a browser or browser-enabled application, such as Microsoft™, Windows™, and/or Linux. In some embodiments, the N client devices 601A through 601B as well as devices in the platform layer 610 shown may include, for example, personal computers executing a browser application program such as Microsoft Corporation's Internet Explorer™, Apple Computer, Inc.'s Safari™, Mozilla Firefox, and/or Opera.

In at least some embodiments, or in combination of at least one other embodiment described herein, at least one database of M exemplary databases 650A…150B may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that may be stored.

In at least some embodiments, or in combination of at least one other embodiment described herein, the exemplary inventive computer-based systems/platforms, the exemplary inventive computer-based devices, and/or the exemplary inventive computer-based components of the present disclosure may be specifically configured to operate in a cloud computing/architecture such as, but not limiting to: infrastructure a service (IaaS), platform as a service (PaaS), and/or software as a service (SaaS) using a web browser, mobile app, thin client, terminal emulator or other endpoint.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that may be dynamically determined during an execution of a software application or at least a portion of software application.

In at least some embodiments, or in combination of at least one other embodiment described herein, exemplary inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk(TM), TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session or can refer to an automated software application which receives the data and stores or processes the data.

The aforementioned examples are, of course, illustrative and not restrictive.

In at least some embodiments, or in combination of at least one other embodiment described herein, the exemplary inventive computer-based systems/platforms, the exemplary inventive computer-based devices, and/or the exemplary inventive computer-based components of the present disclosure such as for example, the scoring module 640C, may be configured to utilize one or more exemplary AI/machine-learning techniques chosen from, but not limited to, decision trees, boosting, support-vector machines, neural networks, nearest neighbor algorithms, Naive Bayes, bagging, random forests, and the like. In some embodiments and, optionally, in combination of any embodiment described above or below, an exemplary neutral network technique may be one of, without limitation, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:

i) Define Neural Network architecture/model,

ii) Transfer the input data to the exemplary neural network model,

iii) Train the exemplary model incrementally,

iv) determine the accuracy for a specific number of timesteps,

v) apply the exemplary trained model to process the newly-received input data,

vi) optionally and in parallel, continue to train the exemplary trained model with a predetermined periodicity.

In some embodiments and, optionally, in combination of any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node may be activated. In some embodiments and, optionally, in combination of any embodiment described above or below, the exemplary aggregation function may be a mathematical function that combines (e.g., sum, product, etc.) input signals to the node. In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

At least some aspects of the present disclosure will now be described with reference to the following numbered clauses.

Clause 1. A method, comprising: receiving, by at least one computing device, a plurality of datasets; executing, by the at least one computing device, a plurality of machine-learning models on each of the plurality of datasets; generating, by the at least one computing device, for each of the plurality of datasets, a label identifying a best performing one of the plurality of machine-learning models, the best performing one of the plurality of machine-learning models being evaluated based on performance evaluations derived from executing the plurality of the machine-learning models on a same one of the plurality of datasets; executing, by the at least one computing device, a predetermined dataset profiler to extract a set of profiles from each of the plurality of datasets; associating, by the at least one computing device, the label with the set of profiles of the same one of the plurality of datasets for each of the plurality of datasets to form a plurality of label-associated sets of profiles; generating, by the at least one computing device, a meta dataset from the plurality of label-associated sets of profiles; and selecting, by the at least one computing device running a predetermined estimating machine-learning model on the meta dataset, one of the plurality of the machine-learning models as a trained machine-learning model.

Clause 2. The method according to clause 1, further comprising generating a machine-learning pipeline comprising the executing the plurality of machine-learning models on the plurality of datasets to generate the labels, extracting dataset profiles, generating a meta dataset from the labels and profiles, and running the estimating machine-learning model on the meta dataset.

Clause 3. The method according to clause 1, wherein the plurality of datasets comprises user provided real tabular datasets.

Clause 4. The method according to clause 3, wherein each of the real tabular datasets comprise a target column as a first column thereof.

Clause 5. The method according to clause 1, wherein the plurality of datasets comprises a plurality of tabular datasets synthesized with one or more user inputted parameters.

Clause 6. The method according to clause 5, wherein the one or more user inputted parameters comprise bounds on a number of rows in the tabular dataset and a number of features in the tabular dataset.

Clause 7. The method according to clause 1, wherein the performance evaluations comprise a quantitative metric selected from the group consisting of F1 score, root mean squared error (RMSE), accuracy, area under a receiver operating characteristic curve (AUC-ROC), mean absolute error (MAE) and any combination of thereof.

Clause 8. The method according to clause 1, wherein the dataset profiler may be configured to extract a profile selected from the group consisting of a number of observations in the dataset, a feature count, a class ratio, a percentage of duplicate records, a percent of features that have binary data, and any combination thereof.

Clause 9. The method according to clause 1, wherein the predetermined estimating machine-learning model may be a gradient boosted tree model.

Clause 10. The method according to clause 1, wherein the selected one of the plurality of the machine-learning models may be a best performing one of the plurality of the machine-learning models on the meta dataset.

Clause 11. A system, comprising: at least one computing device; and at least one memory storing a plurality of computing instructions configured to instruct the at least one computing device to: receive a plurality of datasets; execute a plurality of machine-learning models on each of the plurality of datasets; generate for each of the plurality of datasets, a label identifying a best performing one of the plurality of machine-learning models, the best performing one of the plurality of machine-learning models being evaluated based on performance evaluations derived from executing the plurality of the machine-learning models on a same one of the plurality of datasets; execute a predetermined dataset profiler to extract a set of profiles from each of the plurality of datasets; associate the label with the set of profiles of the same one of the plurality of datasets for each of the plurality of datasets to form a plurality of label-associated sets of profiles; generate a meta dataset from the plurality of label-associated sets of profiles; and run a predetermined estimating machine-learning model on the meta dataset to select one of the plurality of the machine-learning models as a trained machine-learning model.

Clause 12. The system according to clause 11, wherein the plurality of computing instructions are further configured to instruct the at least one computing device to generate a machine-learning pipeline to execute the plurality of machine-learning models on the plurality of datasets to generate the labels, extract dataset profiles, generate a meta dataset from the labels and profiles, and run the estimating machine-learning model on the meta dataset.

Clause 13. The system according to clause 11, wherein the plurality of datasets comprises user provided real tabular datasets.

Clause 14. The system according to clause 13, wherein each of the real tabular datasets comprise a target column as a first column thereof.

Clause 15. The system according to clause 11, wherein the plurality of datasets comprises a plurality of tabular datasets synthesized with one or more user inputted parameters.

Clause 16. The system according to clause 15, wherein the one or more user inputted parameters comprise bounds on a number of rows in the tabular dataset and a number of features in the tabular dataset.

Clause 17. The system according to clause 11, wherein the performance evaluations comprise a quantitative metric selected from the group consisting of F1 score, root mean squared error (RMSE), accuracy, area under a receiver operating characteristic curve (AUC-ROC), mean absolute error (MAE) and any combination of thereof.

Clause 18. The system according to clause 11, wherein the dataset profiler may be configured to extract a profile selected from the group consisting of a number of observations in the dataset, a feature count, a class ratio, a percentage of duplicate records, a percent of features that have binary data, and any combination thereof.

Clause 19. The system according to clause 11, wherein the predetermined estimating machine-learning model may be a gradient boosted tree model.

Clause 20. The system according to clause 11, wherein the selected one of the plurality of the machine-learning models may be a best performing one of the plurality of the machine-learning models on the meta dataset.

Publications cited throughout this document are hereby incorporated by reference in their entirety. While one or more embodiments of the present disclosure have been described, it may be understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

1. A method, comprising:
receiving, by at least one computing device, a plurality of datasets;
executing, by the at least one computing device, a plurality of machine-learning models on each of the plurality of datasets;
generating, by the at least one computing device, for each of the plurality of datasets, a label identifying a best performing one of the plurality of machine-learning models, the best performing one of the plurality of machine-learning models being evaluated based on performance evaluations derived from executing the plurality of the machine-learning models on a same one of the plurality of datasets;
executing, by the at least one computing device, a predetermined dataset profiler to extract a set of profiles from each of the plurality of datasets;
associating, by the at least one computing device, the label with the set of profiles of the same one of the plurality of datasets for each of the plurality of datasets to form a plurality of label-associated sets of profiles;
generating, by the at least one computing device, a meta dataset from the plurality of label-associated sets of profiles; and
selecting, by the at least one computing device running a predetermined estimating machine-learning model on the meta dataset, one of the plurality of the machine-learning models as a trained machine-learning model.

2. The method according to claim 1, further comprising generating a machine-learning pipeline comprising the executing the plurality of machine-learning models on the plurality of datasets to generate the labels, extracting dataset profiles, generating a meta dataset from the labels and profiles, and running the estimating machine-learning model on the meta dataset.

3. The method according to claim 1, wherein the plurality of datasets comprises user provided real tabular datasets.

4. The method according to claim 3, wherein each of the real tabular datasets comprise a target column as a first column thereof.

5. The method according to claim 1, wherein the plurality of datasets comprises a plurality of tabular datasets synthesized with one or more user inputted parameters.

6. The method according to claim 5, wherein the one or more user inputted parameters comprise bounds on a number of rows in the tabular dataset and a number of features in the tabular dataset.

7. The method according to claim 1, wherein the performance evaluations comprise a quantitative metric selected from the group consisting of F1 score, root mean squared error (RMSE), accuracy, area under a receiver operating characteristic curve (AUC-ROC), mean absolute error (MAE) and any combination of thereof.

8. The method according to claim 1, wherein the dataset profiler is configured to extract a profile selected from the group consisting of a number of observations in the dataset, a feature count, a class ratio, a percentage of duplicate records, a percent of features that have binary data, and any combination thereof.

9. The method according to claim 1, wherein the predetermined estimating machine-learning model is a gradient boosted tree model.

10. The method according to claim 1, wherein the selected one of the plurality of the machine-learning models is a best performing one of the plurality of the machine-learning models on the meta dataset.

11. A system, comprising:
at least one computing device; and
at least one memory storing a plurality of computing instructions configured to instruct the at least one computing device to:
receive a plurality of datasets;
execute a plurality of machine-learning models on each of the plurality of datasets;
generate for each of the plurality of datasets, a label identifying a best performing one of the plurality of machine-learning models, the best performing one of the plurality of machine-learning models being evaluated based on performance evaluations derived from executing the plurality of the machine-learning models on a same one of the plurality of datasets;
execute a predetermined dataset profiler to extract a set of profiles from each of the plurality of datasets;
associate the label with the set of profiles of the same one of the plurality of datasets for each of the plurality of datasets to form a plurality of label-associated sets of profiles;
generate a meta dataset from the plurality of label-associated sets of profiles; and
run a predetermined estimating machine-learning model on the meta dataset to select one of the plurality of the machine-learning models as a trained machine-learning model.

12. The system according to claim 11, wherein the plurality of computing instructions are further configured to instruct the at least one computing device to generate a machine-learning pipeline to execute the plurality of machine-learning models on the plurality of datasets to generate the labels, extract dataset profiles, generate a meta dataset from the labels and profiles, and run the estimating machine-learning model on the meta dataset.

13. The system according to claim 11, wherein the plurality of datasets comprises user provided real tabular datasets.

14. The system according to claim 13, wherein each of the real tabular datasets comprise a target column as a first column thereof.

15. The system according to claim 11, wherein the plurality of datasets comprises a plurality of tabular datasets synthesized with one or more user inputted parameters.

16. The system according to claim 11, wherein the performance evaluations comprise a quantitative metric selected from the group consisting of F1 score, root mean squared error (RMSE), accuracy, area under a receiver operating characteristic curve (AUC-ROC), mean absolute error (MAE) and any combination of thereof.

17. The system according to claim 11, wherein the dataset profiler is configured to extract a profile selected from the group consisting of a number of observations in the dataset, a feature count, a class ratio, a percentage of duplicate records, a percent of features that have binary data, and any combination thereof.

18. The system according to claim 11, wherein the predetermined estimating machine-learning model is a gradient boosted tree model.

19. The system according to claim 11, wherein the selected one of the plurality of the machine-learning models is a best performing one of the plurality of the machine-learning models on the meta dataset.

20. A system, comprising:
at least one computing device; and
at least one memory storing a plurality of computing instructions configured to instruct the at least one computing device to:
receive a plurality of datasets consisting of tabular datasets synthesized with one or more user inputted parameters having bounds on a number of rows and a number of features in the dataset;
execute a plurality of machine-learning models on each of the plurality of datasets;
generate for each of the plurality of datasets, a label identifying a best performing one of the plurality of machine-learning models, the best performing one of the plurality of machine-learning models being evaluated based on performance evaluations derived from executing the plurality of the machine-learning models on a same one of the plurality of datasets;
execute a predetermined dataset profiler to extract a set of profiles from each of the plurality of datasets;
associate the label with the set of profiles of the same one of the plurality of datasets for each of the plurality of datasets to form a plurality of label-associated sets of profiles;
generate a meta dataset from the plurality of label-associated sets of profiles; and
run a predetermined estimating machine-learning model on the meta dataset to select one of the plurality of the machine-learning models as a trained machine-learning model.
